(19) United States
(12) Patent Application Publication
(10) Pub. No.: US 2024/0066819 A1
(43) Pub. Date: Feb. 29, 2024

(54) METHOD FOR MANUFACTURING A TANK FOR THE CONTAINMENT OF A PRESSURIZED GAS, IN PARTICULAR HYDROGEN

(71) Applicant: FAURECIA SYSTEMES D'ECHAPPEMENT, NANTERRE (FR)

(72) Inventors: Marc MORET, LA CHAPELLE SUR ERDRE (FR); Antoine De BRUX, Guérande (FR)

(21) Appl. No.: 18/280,330

(22) PCT Filed: Mar. 9, 2022
(86) PCT No.: PCT/EP2022/055957

§ 371 Date: Sep. 5, 2023

(30) Foreign Application Priority Data
Mar. 9, 2021 (FR) FR2102315

(51) Int. Cl. B29D 24/00; B29C 45/00; B29C 45/14; B29C 45/16; B29C 70/08; B29C 70/32; B29C 70/44

(52) U.S. Cl. CPC B29D 24/004; B29C 45/0005; B29C 45/14008; B29C 45/14819; B29C 45/16; B29C 70/085; B29C 70/32; B29C 70/443; B29C 2045/1692; B29K 2023/065

(57) ABSTRACT

A method for producing a composite tank is disclosed. The tank has a continuous fiber reinforcement, a prismatic shape, and a thickness “e” for the storage of a pressurized gas in an internal cavity of the tank. The tank comprises fibers extending between two non-contiguous faces of the tank through the internal cavity. The method includes: (i) obtaining a prismatic fibrous preform having a thickness “e” comprising three-dimensional continuous reinforcements throughout its thickness; (ii) impregnating an outer layer of the preform with a polymer over a thickness of less than ¼ of the thickness “e” so as to constitute a composite outer shell extending over all faces of the prism; and (iii) forming a sealed layer constituting an inner lining, having a thickness of less than 1/10th of the thickness “e” between the outer shell and the fibrous network contained in the cavity of the tank.

### CROSS-REFERENCE TO RELATED APPLICATIONS

This application is the US national phase of PCT/EP2022/055957, which was filed on Mar. 9, 2022 claiming the benefit of French Application No. 21 02315, filed on Mar. 9, 2021, which is incorporated herein by reference in its entirety.

### TECHNICAL FIELD

The disclosure relates to a method for manufacturing a tank capable of containing a pressurized gas, of reduced bulk, more particularly, but not exclusively, in the form of a prismatic plate.

### BACKGROUND

The storage of a pressurized gas in a transportable tank is generally carried out in a cylindrical or spherical tank, made of metal or of composite material.

Because of its low density, hydrogen gas is stored at relatively high pressures, commonly between 200 bars and 700 bars (2*10⁷ to 7*10⁷ Pa).

This type of tank from the prior art, by its shape and its volume, is difficult to integrate into a vehicle, this integration generally being done at the expense of the passenger compartment of said vehicle.

A tank of prismatic shape as described in document U.S. Pat. No. 8,651,268 is easier to integrate into a vehicle. However, the tank described in this document of the prior art is intended for small capacities, comprised within 5 cm³ and 500 cm³, which are not suitable for most applications in the field of mobility or storage on hydrogen production sites, in particular as an energy vector.

To this end, the inventors have designed a tank described in the co-pending application FR2102314, that tank being prismatic in shape and made of a composite material reinforced by continuous fibers and comprises an external shell covering all the faces of the prism and defining an internal cavity for the storage of the gas, which tank comprises reinforcing fibers extending, inside said internal cavity, between two non-contiguous faces of the tank.

Thus, the fiber reinforcements inside the tank participate in the strength thereof and make it possible to better distribute the stresses in the outer shell with respect to the stress generated by the internal pressure, but also to impart to said tank the structural qualities of a panel with respect to external stresses, which, in combination with its prismatic shape, facilitates the integration of said tank into the structure of a vehicle or an aircraft.

### SUMMARY

The disclosure relates to a method for producing a composite tank having a continuous fiber reinforcement, a prismatic shape and a thickness e, for the storage of a pressurized gas in an internal cavity of said tank, which tank comprises fibers extending between two non-contiguous faces of said tank through the internal cavity, said method comprising the steps of:
i. obtaining a prismatic fibrous preform with a thickness e comprising continuous three-dimensional reinforcements throughout its thickness;
ii. impregnating an outer layer of said preform with a polymer over a thickness of less than ¼ of the thickness e so as to constitute a composite outer shell extending over all the faces of the prism;
iii. forming a sealed layer constituting an inner lining, with a thickness of less than 1/10^{th} the thickness e between the outer shell and the fibrous network contained in the cavity of the tank.

The disclosure is implemented according to the embodiments and the variants disclosed below, which are to be considered individually or according to any operative combination.

The numbering of the steps indicated above does not define the chronological order of performing the steps, this order is different according to the embodiments described below or even according to variants of these embodiments. The same applies when these steps comprise intermediate steps for their implementation, in this case certain intermediate steps can be or are carried out before, after or at the same time as the other main steps or the other intermediate steps of the main step, or even any intermediate steps of these other steps.

The description below specifies when an embodiment is essential.

Unless specified specifically, throughout the text, coordinating conjunction “or” should be understood as inclusive and equivalent to “and/or”.

According to a first embodiment, step iii) of the method according to the disclosure comprises, before step i), a step of:
iii. obtaining a shell constituting the inner shell by a plastic injection method and step i) comprises steps of:
i.a draping fibrous plies on the outer surface of the shell constituting the sealed lining;
i.b inserting fibers by stitching between two non-contiguous faces of the preform through the fibrous plies deposited in step i.a) and the inner shell obtained in step iii.a).

This embodiment is particularly more suitable for mass production.

According to this embodiment, the inner shell obtained in step iii.a) comprises hollow spacers extending between two of its non-contiguous faces and the fibers inserted by stitching in step i.b) pass within the hollow spacers.

According to a second embodiment of the method according to the disclosure, step ii) comprises, after step i), steps of:
ii.a packing the preform obtained in step i) into a sealed enclosure;
ii.b. creating a vacuum within the enclosure comprising the preform;
ii.c filling the enclosure comprising the preform with a liquid;
ii.d freezing the preform soaked with the liquid;
ii.e freeze-drying an outer layer of the preform;
ii.f impregnating said outer layer of a polymer so as to constitute the outer shell;
ii.g discharging the remaining liquid from the preform.

This embodiment makes it possible, by the presence of the liquid, to impregnate polymer during step ii), only the outer layer constituting the future outer shell. As it does not require specially machined tooling, this embodiment is more suitable for individual or custom manufacturing.

According to alternative embodiments, the liquid introduced in step ii.c) is water or a sol-gel.

Advantageously, the method according to the disclosure comprises a step, before or after the step ii) of impregnating the outer shell, includes integrating into the preform a coupling passing through said outer shell and able to put into fluid communication the inside of the preform and the outside.

This coupling is advantageously, but not necessarily, used in the finished part for filling the gas tank and drawing the gas from said tank, but is also used during the manufacturing method that is the subject of the disclosure.

Thus, when the liquid introduced during step ii.c) is water, the coupling is used in step ii.g) to suck the water out from the preform and the method comprises during step iii), once the water is discharged, a step of:
iii.b solidifying the fibrous network inside the internal cavity.

According to one variant, step iii.b) comprises spraying a polymer through the coupling inside the preform so as to constitute the inner lining and strengthen the fibrous network within said cavity.

According to another variant, step iii.b) comprises the injection of a sol-gel into the internal cavity and the solidification of the fibrous network in said cavity by evaporation of the liquid phase of the sol-gel.

When the liquid introduced during step ii.c) is a sol-gel, the coupling is used during step ii.g) to evaporate the liquid phase of the sol-gel inside the preform and step iii) is carried out by the polymerization of the sol-gel.

Advantageously, the method according to the disclosure comprises, after step iii), a step of:
iv. creating holding strips surrounding the tank by filament winding.

### BRIEF DESCRIPTION OF THE DRAWINGS

The disclosure is disclosed below according to its preferred embodiments, which are in no way limiting, with reference to FIGS. 1 to 12 wherein:

FIG. 1 shows a perspective top-down view of an embodiment of the tank according to the disclosure;

FIG. 2 shows, in a perspective view, an example integration of a tank according to the disclosure into an automobile frame.

FIG. 3 shows, in a perspective view, an example integration of a tank according to the disclosure into the floors of an aircraft;

FIG. 4 shows, in a defined sectional view DD [FIG. 1], a first embodiment of the structure of the tank according to the disclosure;

FIG. 5 schematically shows, in a defined sectional view DD [FIG. 1], the inner structure of the tank, according to another embodiment;

FIG. 6 is a block diagram of a first embodiment of the method according to the disclosure;

FIG. 7 is a block diagram of a second embodiment of the method according to the disclosure;

FIG. 8 shows a variant of the draping step of the method of the disclosure according to its second embodiment;

FIG. 9 schematically shows, in a sectional view, an example of a tool for the implementation of the method according to the disclosure;

FIG. 10 is a defined partial sectional view along AA [FIG. 1], of an example integration of a coupling, and comprises a cutaway detail view of said coupling;

FIG. 11 shows, according to a defined partial sectional view BB [FIG. 1], another example of integration of a coupling according to the method of the disclosure; and

FIG. 12 shows a third integration of a coupling according to the method of disclosure, in a defined partial sectional view CC [FIG. 1];

### DETAILED DESCRIPTION

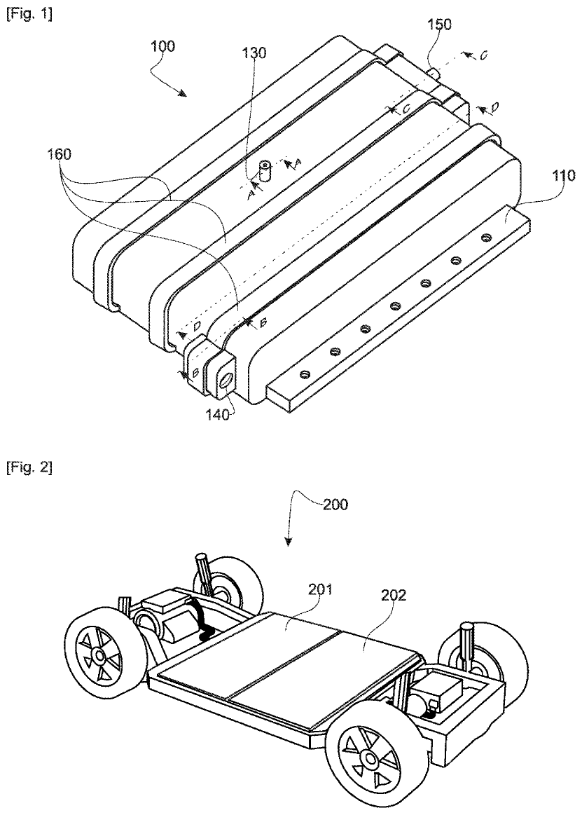

As shown in [FIG. 1], according to one embodiment, the tank (100) obtained by the method according to the disclosure is of generally prismatic shape with a rectangular base and is adapted to contain a pressurized gas, in particular hydrogen, at a pressure that can range up to 1000 bar (10⁸ Pa)

Said tank optionally comprises a flange (110) enabling it to be attached in any way, in particular by bolting, to any structure, in particular that of a vehicle. Said flange is advantageously integrated into the composite shell during the manufacture of the tank and is made of the same piece as said shell.

The tank (100) comprises a coupling (130, 140, 150) to allow the filling and drawing of the gas it contains.

[FIG. 1] shows three exemplary embodiments of couplings on the same tank, the person skilled in the art understands that only one coupling according to any one of these embodiments is necessary, without excluding the possibility of a plurality of couplings on the same tank.

According to one embodiment, the tank (100) comprises one or more reinforcing strips (160) intended, on the one hand, to hold the couplings and on the other hand to improve the resistance of the tank, with respect to both the internal pressure and the external stresses that it undergoes during its use.

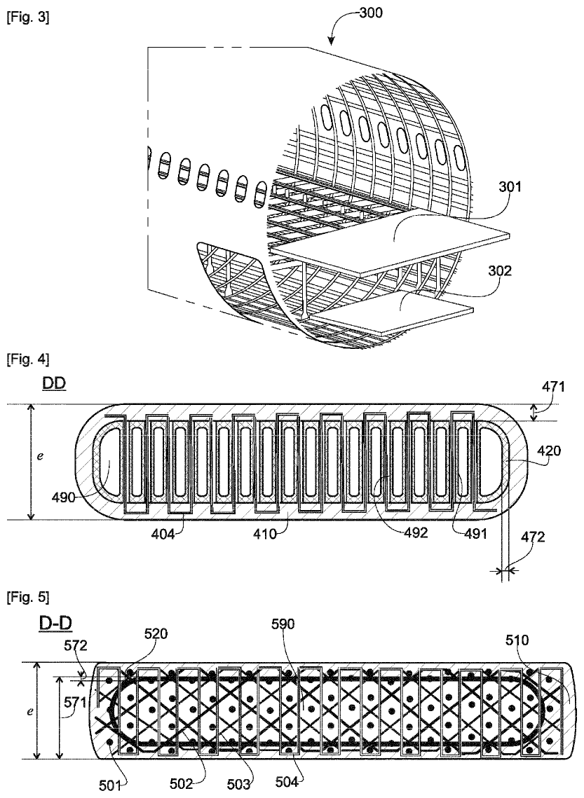

In [FIG. 2] and [FIG. 3], according to example uses, the tank (201, 202, 301, 302) of the disclosure is integrated as a floor element in a structure, for example in the chassis (200) of an electric vehicle with a fuel cell or in the passenger floor or the cargo floor of the structure of an aircraft (300).

Regardless of the embodiment, the tank comprises an outer shell made of a composite material with fiber reinforcements and continuous polymer matrix and a sealed internal cavity delimited by the inner surfaces of the outer shell, the internal cavity comprising a plurality of open cells, delimited by reinforcements extending between the faces of the outer shell. Thus, in addition to its role as the container, the cavity of the tank has a structural role both with respect to the tank's strength at the internal pressure and the tank's resistance to external stresses.

The method according to the disclosure aims to create the outer shell and the cellular cavity, according to different embodiments.

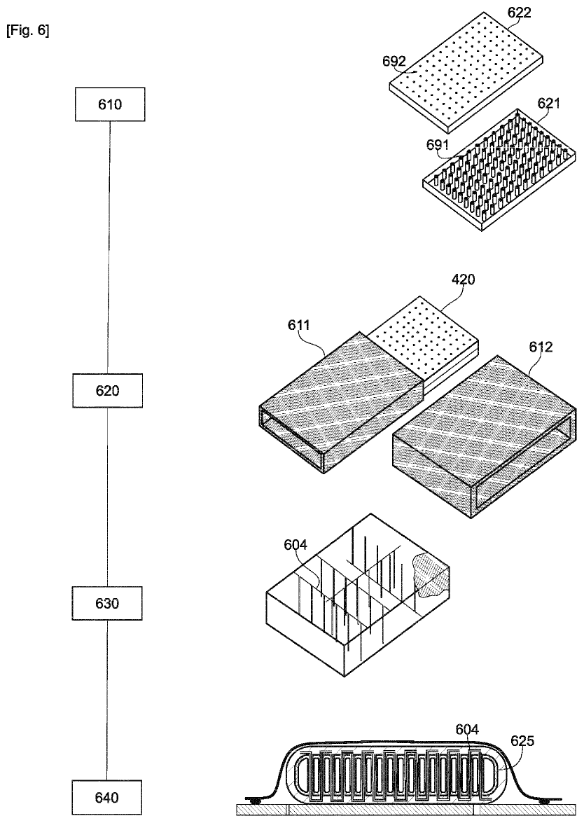

As shown in [FIG. 4], according to a first embodiment, the tank according to the disclosure comprises an inner shell (420), comprising a plurality of hollow spacers (491), extending between two faces of said inner shell and distributed over the entire surface of these two faces.

Said hollow spacers (491) are of any shape, but are discontinuous so as not to seal off sections of the internal volume of said inner shell (420). Likewise, said spacers are not necessarily perpendicular to the walls between which they extend.

According to this embodiment, the open cells are delimited in the internal cavity by said spacers.

According to this embodiment, the tubular spacers (491) are cylindrical and are made from the same part as the walls of the inner shell and their bores (492) pass through said walls.

The inner shell (420) delimits a sealed internal cavity (490) able to contain a gas. Said inner shell is, according to exemplary embodiments, made of high-density polyethylene or polyamide PA6.

The outer shell (410) is made of a composite material with a continuous polymer and fibrous reinforcement matrix, comprising a stack of fibrous plies in a plurality of reinforcement directions, for a fiber content of between 40% and 65% of carbon, glass, aramid fibers or any combination thereof, without these examples being limiting.

Fibers (404) extend into the outer shell (410) and between the faces thereof, passing through the internal cavity (490) of the tank into the bores (492) of the hollow spacers (491). These fibers (404) are impregnated with the polymer, which is thermosetting or thermoplastic, constituting the matrix of the outer shell, which fills the bores (492) of the hollow spacers.

Thus, the hollow spacers (491) comprising fibers (404) constituting transverse reinforcements, tensioned by the pressure in the internal cavity (490) and participating in the strength and resistance of the tank. They also constitute stiffeners contributing to the rigidity and bending strength of the composite plate formed by the tank.

In [FIG. 5], according to a second embodiment, the tank is in the form of a three-dimensional network of fibrous plies, of carbon, glass, aramid either alone or in any combination, so as to give said tank properties of mechanical strength and resistance to pressure, impacts and indentations, depending on the intended application.

The tank comprises an external shell (510) wherein the fibers are trapped in a polymer matrix, of a thermoplastic or thermosetting nature, thus constituting a composite shell with continuous fibrous reinforcements. This shell (510) extends over the 6 faces of the prism and comprises, on its inner face, a sealed lining (520).

This sealed lining (520) delimits an internal cavity (590) wherein the gas, in particular dihydrogen, may be contained under pressure.

Fibers (501, 502, 503, 504) contained in the outer shell on one of the faces of the prism, where they are trapped in the matrix, extend to another face of the shell where they are also trapped in the polymer matrix, passing through the internal cavity (590) of the tank. The fiber content in the internal cavity is greatly reduced compared to the fiber content in the shell. Thus, the fibers or sets of fibers in the internal cavity delimit open cells in this cavity.

Regardless of the embodiment, the tank is in the form of a prismatic plate with a thickness of e preferably less than or equal to 1/10^{th} the largest side of the prism.

The thickness (471, 571) of the outer shell (410, 510) is a function of the pressure of the gas that will be contained in the tank and of the stresses experienced by the tank in the structure wherein it is integrated, of the nature and of the content of fibers as well as of the nature of the polymer. This thickness is typically less than ¼ of the thickness e, preferentially less than 1/10^{th} of the thickness e of the tank and is determined by calculation according to the data cited.

The thickness of the inner lining (420, 520) is typically less than 1/10^{th} the thickness e, preferentially less than 1/30^{th} the thickness e.

As shown in [FIG. 6], according to a first embodiment of the method according to the disclosure, adapted to the version of the tank shown [FIG. 4], a first step (610) includes obtaining the shell constituting the inner shell of the tank.

According to one embodiment, this step implements a plastic injection method.

According to a first variant, the method includes obtaining two half-shells (621, 622) each comprising hollow half-spacers (691) whose bores (692) pass through the wall of the respective half-shell to which they are attached.

The half-shells are then assembled, for example by sealed welding, so as to constitute the inner shell of the tank.

According to another alternative (not shown), obtaining the inner shell implements an injection/expansion method.

As a non-limiting example, the inner shell is made of high-density polyethylene or polyamide (PA6).

Although [FIG. 6] shows a particular example where the spacers (691) are cylindrical in shape, the person skilled in the art understands that these can take a wide variety of shapes.

In a step of draping (620) continuous fibers (611, 612) are deposited on the external faces of the inner shell (420) obtained in the preceding step (610). According to exemplary embodiments, this step is implemented by manual or automatic draping, by overbraiding, the inner shell being used as a core, or by threading said inner shell (625) into one or more sleeves obtained in 3D knitting, or by filament winding techniques around said inner shell (420).

The fibers (611, 612) deposited during the draping step constitute most of the continuous reinforcements of the future outer shell of the tank that is the subject matter of the disclosure.

Depending on the nature of the composite material intended to constitute the outer shell and the depositing method, the fibers (611, 612) deposited during the draping step (620) are dry fibers, fibers pre-impregnated with a thermosetting or thermoplastic polymer by powdering, filming or undercasting.

During a stitching step (630), fibers are stitched into the preform obtained after the draping step (620), along stitching lines (604). Advantageously, the fibers thus stitched pass through the bores of the spacers and pass through the entire thickness of the preform so as to constitute the future transverse reinforcements of the tank.

Thus, the fibers (604) inserted by stitching into the preform extend both in the future cavity in the bores of the spacers and substantially perpendicularly to the walls of the tank that they connect, but also in the thickness of the walls of the tank substantially parallel to these walls.

During an impregnation and solidification step (640), the fibrous stack forming the outer shell is impregnated with the polymer and solidified to obtain a composite material with fiber reinforcement both in the outer shell and in the transverse reinforcements.

Depending on the nature of the fibers and the polymer(s) constituting the matrix, the impregnation and solidification step (640) is obtained by injection or infusion of resin, according to known methods in the case of dry fibers and a thermosetting matrix, this injection being followed by a firing, or by melting-crosslinking or melting-solidifying if the fibers are impregnated with a thermosetting or thermoplastic polymer, or a combination of these various processes, in particular if the outer shell comprises several polymers, for example a thermoplastic polymer matrix on an outer layer so as to improve its impact strength.

These impregnation-solidification methods are known from the prior art and are not explained above. They are implemented under vacuum or under pressure, in an autoclave or in autonomous equipment.

Compared to the other embodiments described below, this first embodiment is more suitable for a mass-produced embodiment. The operations for manufacturing the inner shell by injection-welding or injection-blowing, the manufacture of fiber sleeves by 3D knitting or overbraiding from dry fibers or impregnated with a thermoplastic polymer, and finally the impregnation-solidification operations can be carried out at distant production sites implementing the corresponding specific methods.

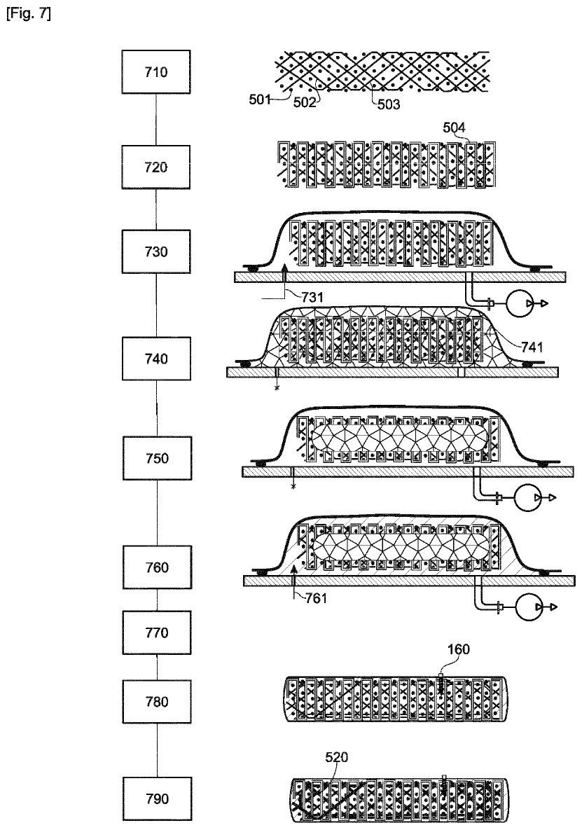

As shown in [FIG. 7], according to another embodiment, more suitable, but not exclusively, for manufacturing on a measurement or unit, a substantially prismatic dry preform is obtained during a draping step (710).

This embodiment corresponds to that of the tank shown in [FIG. 5].

In this case, the general principle, according to alternative embodiments disclosed below, the method includes of filling the fiber preform obtained with a liquid, and for controlling via this liquid, the impregnated zone for constituting the outer shell.

According to one example embodiment, the draping uses stretchable three-dimensional fabrics of the interwoven type, commonly referred to as interlock, comprising weft fibers connecting lateral faces of the prism (501), and warp fibers, woven so that their cross-sectional orientation varies between 0° and 45° (502, 503) respectively ensuring the bond between the other 2 lateral faces as well as between the upper and lower faces of the prism.

According to a stitching step (720), the preform thus obtained is reinforced by stitches (504) extending between two opposite faces of the prism.

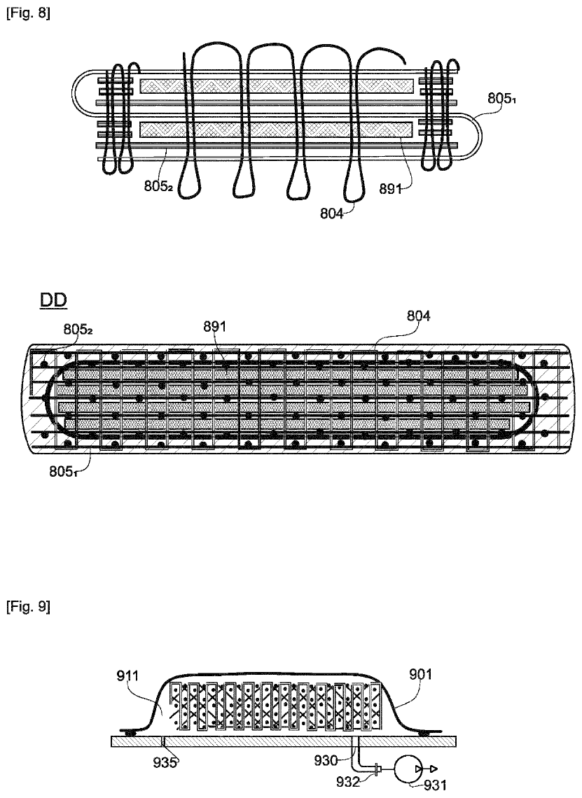

In [FIG. 8], alternatively, the draping step creates a fibrous network comprising, in the zone corresponding to the future internal cavity, spacers (891) made of a three-dimensional nonwoven in order to generate a storage volume. In this variant, the fiber network comprises a stack of twill-type or taffeta-type fabrics (805₁, 805₂) in intersecting directions, connecting the lateral faces of the tank.

In the same way, this dried preform is reinforced by stitches (804) extending between opposite faces.

Thus, the fibers (804) inserted into the preform extend both in the future cavity, substantially perpendicularly to the walls of the tank that they connect, but also in the thickness of the walls of the tank substantially parallel to these walls.

The terms “three-dimensional nonwovens” should be interpreted broadly. According to non-limiting examples, it is a foam comprising open cells or a non-woven mat of polymer wires.

Returning to [FIG. 7], according to a step of filling (730), preparatory to impregnation, the dry preform is placed in a tool comprising a sealed cavity in which a vacuum is created. Once there is a vacuum inside, the sealed cavity comprising the preform is filled with a liquid (731) injected into the tool.

[FIG. 9] shows an example of the principle of this tool. According to this embodiment, the tool comprises a tarpaulin (901) defining a sealed cavity (911) wherein the preform is contained. Said tool comprises one or more suction orifices (930) connected to a vacuum pump (931), which is protected by a semi-permeable membrane (932) of expanded polytetrafluoroethylene, more commonly referred to under the trade name GoreTex®, as well as one or more injection orifices (935), comprising a valve (not shown). The pump (931) makes it possible to evacuate the cavity (911) and the injection port (935) to fill said cavity.

During the implementation of the method that is the subject of the disclosure, the tool is placed in one or more successive chambers whose temperature is controlled.

According to variants, a single tool is used for all the steps of the specific method or multiple tools are used at the various steps.

Thus, during the step of filling (730) a vacuum is produced inside of the tool comprising the dry preform by drawing air out through the suction port, then it is filled with liquid (731) via the injection port.

According to a first alternative embodiment, the liquid (731) used during the filling step is water and said filling step is followed by a step of freezing (740). During this step, the tool assembly, comprising the preform completely soaked with water, is brought to a temperature of between −20° C. and −80° C., so as to freeze the water. The preform is then trapped in the ice (741).

During a sublimation step (750), the assembly is gradually heated under vacuum so as to sublimate part of the ice trapping the preform. This sublimation process is controlled by the temperature rise rate and the vacuum pressure. These conditions have been developed through tests.

According to one alternative embodiment, this sublimation step is carried out while the preform is placed in a tool, the suction feature thereof being used to control the vacuum and the tool being placed in an enclosure allowing temperature control.

According to another variant, this step is carried out by taking the preform, drawn from the ice, out of the tool and by placing the preform in a freeze-drying chamber wherein the vacuum and the temperature are controlled. In this case, the preform is placed into a tool for the subsequent steps to be carried out.

In both cases, the heating being carried out by the outside of the preform, the thickness of the sublimated ice propagates from the outside toward the center of the preform, freeze-drying the fibers in this thickness, the water vapor being drawn out either through the suction port of the tool or via the freeze-drying chamber.

When a layer of sufficient thickness is freeze-dried, and if necessary after having replaced the preform in an injection or infusion tool, a liquid resin (761) is injected or infused into said layer, during an injection step (760) so as to impregnate the freeze-dried fibers. The rest of the fibers of the preform remains trapped in the ice.

Thus, during the injection of resin, only the outer layer is impregnated so as to constitute the outer shell of the preform.

During a firing step (770), the resin injected into the future external shell is crosslinked to confer its mechanical properties thereon. The water resulting from the melting of the ice remains trapped inside the preform, which will form the future cavity of the tank.

The blank thus obtained is then removed from the mold.

During a step of emptying (780) one or more couplings (160) passing through the outer shell to the inside of the blank obtained in the preceding step are inserted and used to drain the water contained inside said blank.

After emptying and drying, during a step (790) of solidifying the cellular cavity, the resin is sprayed by the coupling(s) (160) inside the preform so as to constitute the sealed lining (520) and to impregnate the fibers in the cavity.

Outside the sealed lining (520), the fibers are simply impregnated during spraying so as to give them a certain rigidity without constituting a matrix, thus leaving a free cellular volume inside the cavity to contain a gas.

According to one alternative embodiment (not shown), the fitting installed in preparation of the emptying step (780), or a part thereof, is installed in the preform at the time of the draping step or between the draping step (720) and the step of preparing (730).

In this case, said coupling is for example made in two parts, one of said parts, called the connector, is integrated into the preform, flush with the external face of the preform, and closed by a cap.

Advantageously, this same coupling is used to fill or withdraw the gas from the future tank, optionally by connecting another form of connection to the connector.

According to one alternative embodiment, the filling step (730) implements a sol-gel filling the cavity containing the preform.

The following steps are the same, up to the emptying step (780), in which the liquid phase of the sol-gel is evaporated, through the one or more couplings, for example by heating the blank obtained in the preceding step. Thus, the step (790) of solidifying the cellular cavity is carried out by the condensation of the sol-gel on the fibers at the same time as its liquid phase is removed by evaporation.

Thus, according to this variant, both during the freeze-drying step and during the emptying and combined solidification step, the sol-gel polymerizes respectively at the surface of the future cavity on the outer shell side, then inside the cavity of the tank on the fibers contained in this cavity during the emptying step, thus producing the sealed lining.

According to yet another embodiment, the liquid (731) injected during the filling step is water and the method takes place as described above, up to and including the step of emptying (780).

Prior to the solidification step (790), a sol-gel is injected into the internal cavity previously emptied of its water and dried.

The solidification step is thus carried out by evaporation of the liquid phase of the sol-gel and its polymerization on the fibers in the internal cavity.

Regardless of the embodiment, the proportion of fibers in the outer shell is between 40% and 65% so as to impart high mechanical properties to that shell,

The proportion of fibers in the internal cavity is significantly reduced and comprised between 4% and 10%.

Thus, the fibers included in the outer shell and which extend through the cavity between two faces participate in the mechanical strength of the tank both with respect to the internal pressure and external stresses, but provide within the cavity a volume able to contain a pressurized gas. These values are indicative of a preferred embodiment relating to a compromise between the mechanical strength and capacity of the tank, but the person skilled in the art understands that this fiber content in the cavity is, depending on the intended application, advantageously raised to increase the mechanical strength to the detriment of capacity, or vice versa.

The embodiments set forth above consider an internal cavity of a single volume, the transverse reinforcements extending into said cavity without carrying out a compartmentalization thereof.

The person skilled in the art understands that the method according to the disclosure makes it possible, regardless of the embodiment considered, to create a compartmentalized internal cavity, the latter being easily adapted by implementing the described steps compartment by compartment, except as regards the impregnation and solidification of the outer shell.

Returning to [FIG. 1], regardless of the method implemented, the tool comprises one or more couplings (160) intended to fill and withdraw from the tank. Said couplings are advantageously integrated into the fibrous preform before it is impregnated with the polymer.

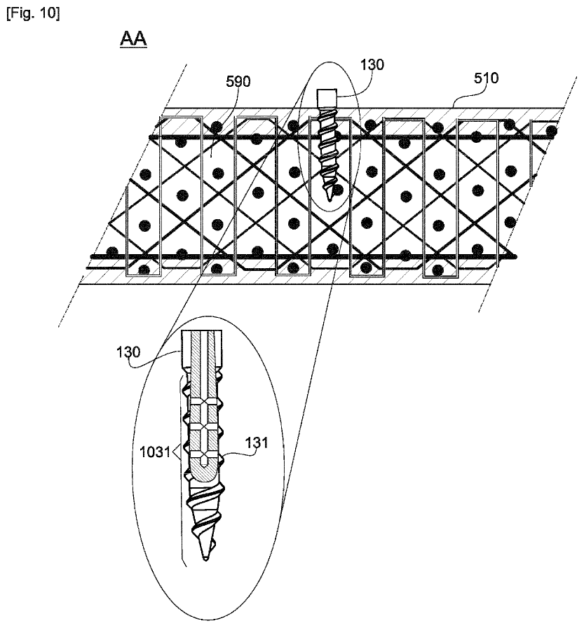

As shown in [FIG. 10], according to a first embodiment, the coupling (130) comprises an outer part for connecting a duct thereto and an inner part (331) extending through the composite shell (510) of the tank into the inner cavity (590). The coupling (130) is for example made of a metallic material, which, depending on the intended application, is chosen to be resistant to the phenomenon of hydrogen embrittlement, for example a copper or aluminum alloy.

According to this example embodiment, the part (1031) of the coupling extending inside the tank is threaded. This thread (131) gives the coupling a tear resistance without damaging the fibers.

In [FIG. 11], according to another embodiment, the coupling (140) is integrated into a coupling block (1140) made of a metallic material, which, depending on the intended application, is chosen to be resistant to the phenomenon of hydrogen embrittlement, for example a copper or aluminum alloy.

FIG. 11 shows a female coupling (140), but the person skilled in the art understands that a male coupling can be realized under the same principles.

The coupling block (1140) comprises a needle (1141), preferably conical, able to penetrate into the fibrous stack into the cavity (590) containing the gas, without damaging the fibers.

One or more holding strips (160), made of metal or preferably composite obtained by filament winding, extend around the tank and ensure the holding of the coupling block (1140) against the tank.

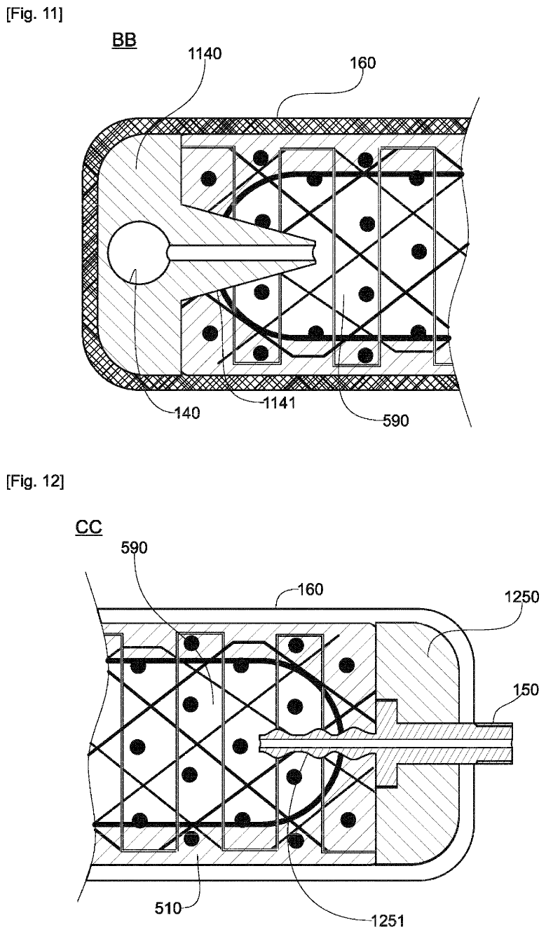

As shown in [FIG. 12], according to another embodiment, the coupling (150) comprises a ribbed needle (1251) penetrating through the outer shell (510) and the fibrous stack, to the inside of the cavity (590) of the tank. As according to the preceding embodiments, the coupling (150) is made of a metallic material, where appropriate resistant to hydrogen embrittlement, such as a copper or aluminum alloy.

According to this example embodiment, said coupling is held in position by a metal flange (1250) which is also held by one or more holding strips (160).

Although the preceding examples show the integration of the different coupling variants in a tank produced according to the version shown in [FIG. 5], the person skilled in the art understands that these embodiments are applicable to the versions of the tank shown in [FIG. 4] and [FIG. 8].

The description above and the exemplary embodiments show that the disclosure achieves the intended goal by proposing an economical method adapted to mass-production or individual manufacturing of a prismatic composite tank comprising a sealed internal cavity able to contain a pressurized gas and transverse reinforcements passing through said cavity between non-contiguous faces of the tank.

1. A method for a manufacture of a composite tank having a continuous fiber reinforcement, a prismatic shape, and a thickness e, for storage of a pressurized gas in an internal cavity of said composite tank, said composite tank comprising fibers extending between two non-contiguous faces of said composite tank through the internal cavity, wherein the method comprises the steps of:
i. obtaining a prismatic fibrous preform with a thickness e comprising continuous three-dimensional reinforcements throughout the thickness;
ii. impregnating an outer layer of said prismatic fibrous preform with a polymer over a thickness of less than ¼ of the thickness e so as to constitute a composite outer shell extending over all faces of the prismatic shape; and
iii. forming a sealed layer constituting an inner lining, a thickness less than 1/10^{th} of the thickness e between the composite outer shell and a fibrous network in the internal cavity of the composite tank.

2. The method according to claim 1, wherein step iii) comprises, before step i), a step of:
iii.a obtaining a shell constituting the inner lining by a plastic injection method and wherein step i) comprises steps of:
i.a draping fibrous plies on an outer surface of the shell constituting the inner lining; and
i.b inserting fibers by stitching between two non-contiguous faces of the prismatic fibrous preform through the fibrous plies deposited in step i.a) and the inner lining obtained in step iii.a).

3. The method according to claim 2, wherein the inner lining obtained in step iii.a) comprises hollow spacers extending between two of non-contiguous faces and wherein the fibers inserted by stitching in step i.b) pass inside the hollow spacers.

4. The method according to claim 1, wherein step ii) comprises, after step i), steps of:
ii.a packing the prismatic fibrous preform obtained in step i) into a sealed enclosure;
ii.b. creating a vacuum within the sealed enclosure comprising the prismatic fibrous preform;
ii.c filling the sealed enclosure comprising the prismatic fibrous preform with a liquid;
ii.d freezing the prismatic fibrous preform soaked with the liquid;
ii.e freeze-drying an outer layer of the prismatic fibrous preform;
ii.f impregnating said outer layer of a polymer so as to constitute the composite outer shell; and
ii.g discharging any remaining liquid from the prismatic fibrous preform.

5. The method according to claim 4, wherein the liquid introduced in step ii.c) is water.

6. The method according to claim 4, wherein the liquid introduced in step ii.c) is a sol-gel.

7. The method according to claim 1, comprising a step, before or after the step ii) of impregnating the composite outer shell, including integrating into the prismatic fibrous preform a coupling passing through said composite outer shell and able to put into fluid communication an inside of the prismatic fibrous preform and an outside of the prismatic fibrous preform.

8. The method according to claim 4 wherein the liquid is water and wherein a coupling is used in step ii.g) to suck the water out from the prismatic fibrous preform and the method comprises during step iii), once the water is discharged, a step of:
iii.b solidifying the fibrous network inside the internal cavity.

9. The method according to claim 8, wherein step iii.b) comprises spraying a polymer through the coupling inside the prismatic fibrous preform so as to constitute the inner lining and solidifying the fibrous network within said internal cavity.

10. The method according to claim 8, wherein step iii.b) comprises an injection of a sol-gel into the internal cavity and solidification of the fibrous network within said internal cavity by evaporation of a liquid phase of the sol-gel.

11. The method according to claim 4, wherein the liquid is a sol-gel and wherein a coupling is used during step ii.g) to evaporate a liquid phase of the sol-gel inside the prismatic fibrous preform, and wherein step iii) is carried out by polymerization of the sol-gel.

12. The method according to claim 7, comprising after step iii) a step of:
iv. creating holding strips surrounding the composite tank by filament winding.
